(19) United States
(12) Patent Application Publication
(10) Pub. No.: US 2025/0187344 A1
(43) Pub. Date: Jun. 12, 2025

(54) CARTRIDGE AND METHOD FOR REMANUFACTURING THE SAME

(71) Applicant: CANON KABUSHIKI KAISHA, Tokyo (JP)

(72) Inventors: ISAO OTANI, Kanagawa (JP); JUNICHIRO IRI, Kanagawa (JP)

(21) Appl. No.: 18/975,998

(22) Filed: Dec. 10, 2024

(30) Foreign Application Priority Data
Dec. 12, 2023 (JP) 2023-209162
Oct. 18, 2024 (JP) 2024-183263

(51) Int. Cl. B41J 2/175

(52) U.S. Cl. CPC B41J 2/17513; B41J 2/17553; B41J 2/17559

(57) ABSTRACT

A cartridge includes at least one absorbent body holding liquid, at least one container having an opening portion, the at least one absorbent body being housed in the container, and a lid member configured to be joined to the opening portion. The lid member includes at least one protrusion. A part of the at least one protrusion is inserted into the at least one absorbent body.

### BACKGROUND

### Field

The present disclosure relates to a cartridge and a method for remanufacturing the cartridge.

### Description of the Related Art

Liquid discharge apparatuses are equipped with a liquid discharge head for discharging liquid, by which various purposes are achieved. For example, in an inkjet printing apparatus, an inkjet printing head that discharges liquid is mounted on a carriage discharges ink onto print media to print images and characters. The liquid to be discharged from the liquid discharge apparatus is supplied to the liquid discharge head from a cartridge that is detachably attached to the liquid discharge apparatus.

Japanese Patent Application Laid-Open No. 2006-44230 discusses a cartridge in which an absorbent body that holds liquid is housed inside a container having an opening portion to which a lid member is joined.

In recent years, there has been a demand for remanufacturing cartridges to realize a sustainable society, such as a decarbonized/circular society. In remanufacturing the cartridge discussed in Japanese Patent Application Laid-Open No. 2006-44230, it is necessary to separate the lid member from the container, and then separate the absorbent body from the container. However, the absorbent body may be closely fitted in the container or the liquid may firmly adhere to the absorbent body, making it difficult to separate the absorbent body from the container. Furthermore, even if the absorbent body is not closely fitted in the container, the separation of the absorbent body from the container is performed in addition to the separation of the lid member from the container, which could increase the takt time.

### SUMMARY

In view of the above issues, the present disclosure advantageously provides a cartridge in which an absorbent body can be easily separated from a container and that reduces the risk of the increase in the takt time, and a method for remanufacturing the cartridge.

According to some embodiments, a cartridge includes at least one absorbent body holding liquid, at least one container having an opening portion, the at least one absorbent body being housed in the container, and a lid member configured to be joined to the opening portion. The lid member includes at least one protrusion. A part of the at least one protrusion is inserted into the at least one absorbent body.

Further features of the present disclosure will become apparent from the following description of exemplary embodiments with reference to the attached drawings.

### BRIEF DESCRIPTION OF THE DRAWINGS

FIG. 1 is a schematic diagram of a print apparatus in which a cartridge can be used according to a first exemplary embodiment of the present disclosure.

FIG. 2 is a perspective view illustrating an external appearance of the cartridge according to the first exemplary embodiment.

FIG. 3 is an exploded perspective view of the cartridge according to the first exemplary embodiment.

FIG. 4A is a cross-sectional view of a lid member and a partition member before the assembly. FIG. 4B is a cross-sectional view illustrating a process of putting together the lid member and the partition member. FIG. 4C is a cross-sectional view of the lid member in which a fixation portion is formed. FIG. 4D is a cross-sectional view illustrating a process of joining the lid member to which the partition member is attached, and a container. FIG. 4E is a cross-sectional view illustrating a state where the partition member is inserted inside the container.

FIG. 5A is a side view illustrating a vibration welding process for the container and the lid member. FIG. 5B is a side view illustrating a process of causing the lid member to vibrate while being pressed against the container with a predetermined pressure.

FIG. 5C is a side view illustrating a state where the container and the lid member are joined together.

FIG. 6 is a flow diagram illustrating a process for remanufacturing a cartridge.

FIG. 7A is a cross-sectional view of a used cartridge. FIG. 7B is a cross-sectional view illustrating a process of separating the lid member from the container. FIG. 7C is a cross-sectional view of the cartridge in a state where the lid member is separated from the container. FIG. 7D is a cross-sectional view of the cartridge in a state where the absorbent body is separated from the lid member. FIG. 7E is a cross-sectional view of the cartridge in a state where the lid member and the partition member are separated.

FIG. 8A is a perspective view of a cartridge having a plurality of absorbent body containment chambers. FIG. 8B is a cross-sectional view of a cartridge having a plurality of absorbent body containment chambers. FIG. 8C is a cross-sectional view of a cartridge in which a plurality of absorbent body containment chambers is divided into a T shape.

FIG. 9 is a schematic diagram of a cartridge according to a second exemplary embodiment.

FIG. 10 is a schematic diagram of a cartridge according to a third exemplary embodiment.

FIG. 11 is a schematic diagram of a cartridge according to a fourth exemplary embodiment.

FIG. 12 is a schematic diagram of a cartridge according to a variation of the fourth exemplary embodiment.

FIG. 13 is a schematic diagram of a cartridge according to a fifth exemplary embodiment.

FIG. 14A is a side view of a lid member before a claw portion is formed.

FIG. 14B is a side view illustrating a process of bringing the tip portion of the protrusion of the lid member into contact with a mold member. FIG. 14C is a side view illustrating a process of melting the tip portion. FIG. 14D is a side view illustrating a process of separating the mold member from the tip portion.

FIG. 15 is a schematic diagram of a cartridge according to a sixth exemplary embodiment.

FIG. 16A is a side view illustrating a state before an uneven portion is formed on the protrusion of a lid member using a mold member. FIG. 16B is a side view illustrating a process of bringing the mold member into contact with the tip portion of the protrusion of the lid member. FIG. 16C is a side view illustrating a process of melting the tip portion.

FIG. 16D is a side view illustrating a process of separating the mold member from the tip portion.

### DESCRIPTION OF THE EMBODIMENTS

Hereinafter, various exemplary embodiments, features, and aspects of the present disclosure will be described with reference to the drawings. The following exemplary embodiments do not limit the present disclosure, and all the combinations of features described in the present exemplary embodiments are not necessarily essential to the solutions of the present disclosure. Like numbers refer to like constituent elements.

### (Inkjet Printing Apparatus)

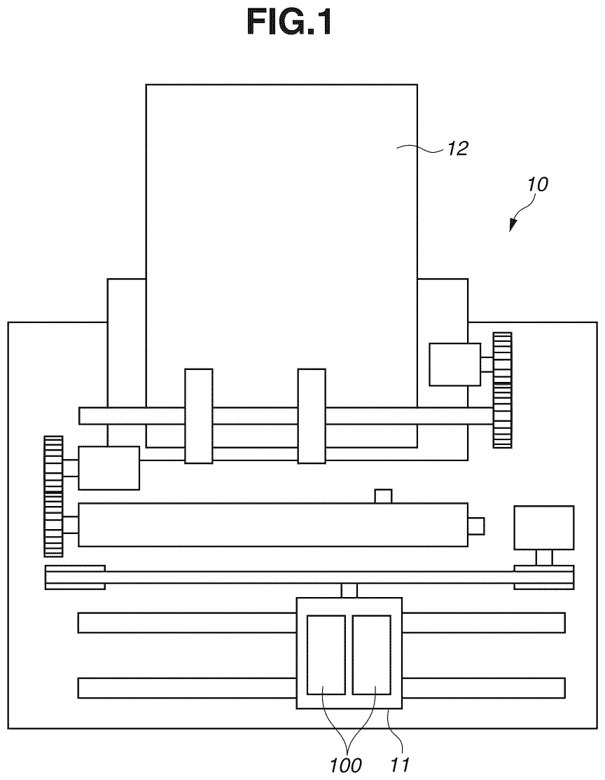

FIG. 1 is a schematic diagram of a liquid discharge apparatus according to a first exemplary embodiment. While the liquid discharge apparatus according to the first exemplary embodiment is an inkjet printing apparatus, the present disclosure is not limited to inkjet printing apparatuses as long as the liquid discharge apparatus is an apparatus that discharges liquid. The inkjet printing apparatus 10 (hereinafter, also referred to as the print apparatus) is an on-carriage type apparatus that employs a serial print method, and includes a cartridge 100 and a carriage 11. The cartridge 100 is mounted on the carriage 11. In the inkjet printing apparatus 10, the carriage 11 reciprocates, a record sheet 12 is transported by a predetermined amount at a time in a direction perpendicular to the reciprocating movement of the carriage 11, and the cartridge 100 discharges ink onto the record sheet 12 to form an image on the record sheet 12.

### (Cartridge Overview)

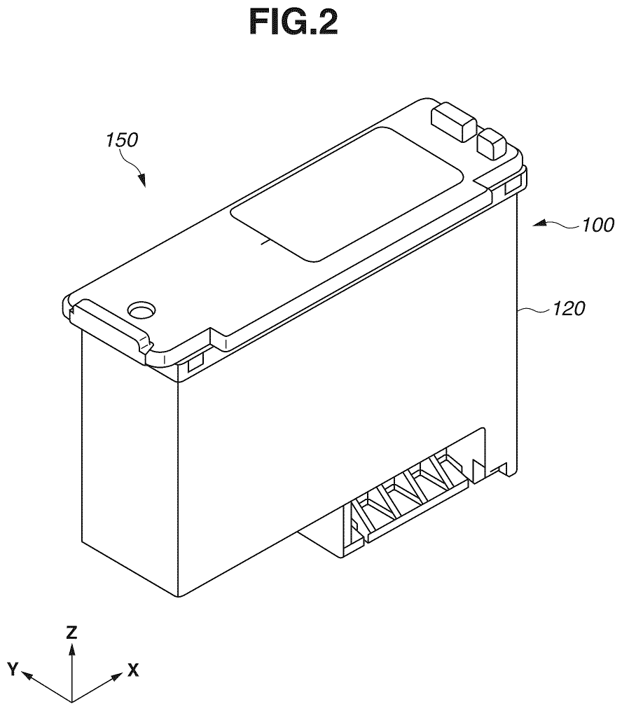

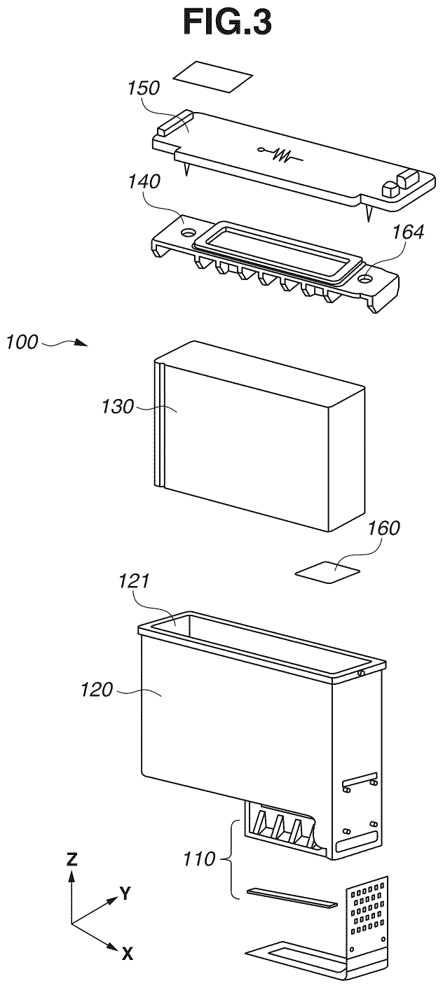

FIG. 2 illustrates a perspective view of the cartridge 100 according to the first exemplary embodiment, and FIG. 3 illustrates an exploded perspective view of the cartridge 100 according to the first exemplary embodiment. The cartridge 100 is of a type that contains ink of one color, and is generally a cartridge for black ink. The present disclosure is also applicable to a type that contains inks in different colors, generally cartridges for color inks (cyan, magenta, and yellow), but in the present exemplary embodiment, a cartridge for black ink will be used for description.

As illustrated in FIG. 3, the cartridge 100 includes a print head (liquid discharge head) 110 that discharges ink, an absorbent body 130 that holds the liquid, a container 120 that includes the absorbent body 130 and the liquid, and a lid member 150 joined to an opening portion 122 of the container 120. Furthermore, the cartridge 100 desirably includes a partition member 140 disposed between the absorbent body 130 and the lid member 150, and a filter 160 that removes foreign matter in the container 120.

The print head 110 is disposed on the bottom surface of the container 120 located on the lower side in the vertical direction, includes a discharge element substrate that discharges the liquid, and discharges ink based on discharge data. The absorbent body 130 is made of a fibrous or porous material, and is capable of holding ink internally by capillary force. The absorbent body 130 is desirably contained in an absorbent body containment chamber 121 of the container 120 and in contact with the filter 160 for removing foreign matter.

The lid member 150 is disposed covering the opening of the container 120, and delimits the absorbent body containment chamber 121 together with the container 120. The partition member 140 is positioned between the absorbent body 130 and the lid member 150 and holds the absorbent body 130 in place. The lid member 150 and the partition member 140 will be described in detail below.

### (Assembly Process)

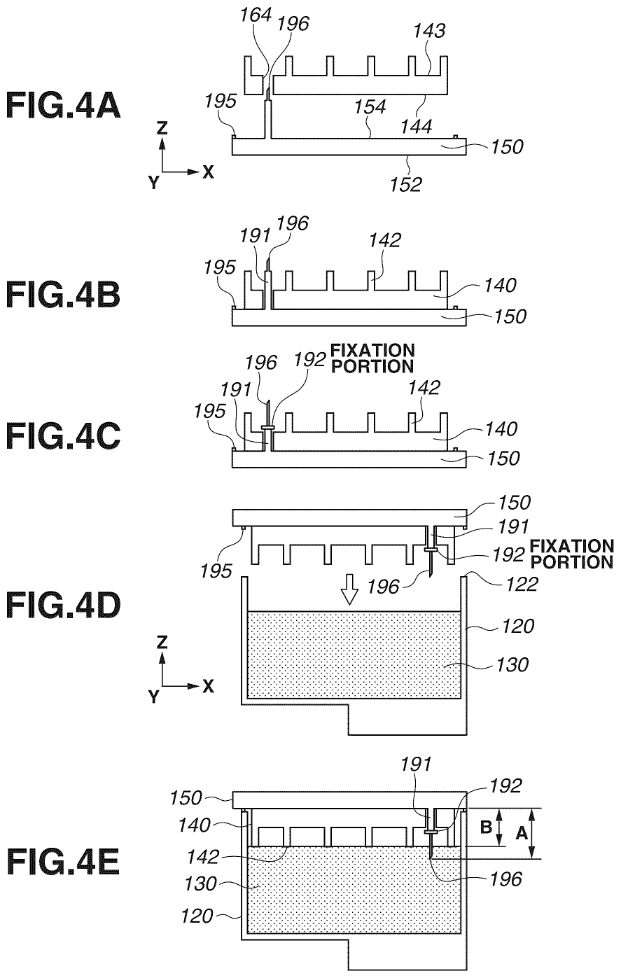

FIGS. 4A to 4E are schematic cross-sectional views of the lid member 150 and the partition member 140 of the cartridge 100 according to the first exemplary embodiment. FIG. 4A illustrates a state before the lid member 150 and the partition member 140 are pieced together. As illustrated in FIG. 4A, the lid member 150 defines a plane in the XY plane, and has a first surface 152 and a second surface 154. The second surface 154 of the lid member 150 includes a welding rib 195 and a protrusion 191 that protrude in the positive Z-axis direction. In the first exemplary embodiment, the central axis of the protrusion 191 is perpendicular to the lid member 150, but the central axis can be inclined. The welding rib 195 can be a separate component to be placed between the lid member 150 and the container 120 when vibration welding between the container 120 and the lid member 150 is performed. The negative Z-axis direction corresponds to the direction of gravity.

The partition member 140 defines a plane in the XY plane, and defines a first surface 143 and a second surface 144. The partition member 140 has a through hole 164 extending through the partition member 140 in the Z-axis direction. The inner diameter of the through hole 164 is larger than the outer diameter of the protrusion 191. The partition member 140 has dimensions in the XY plane that are smaller than the area defined by the welding rib 195. The second surface 144 of the partition member 140 opposite to the first surface 143 includes rib portions 142 protruding in the Z-axis direction.

FIGS. 4B and 4C illustrate a process of piecing together the lid member 150 and the partition member 140. The assembly is performed in the order of FIG. 4B and then 4C. As illustrated in FIG. 4B, the protrusion 191 of the lid member 150 is inserted into the through hole 164 of the partition member 140.

As illustrated in FIG. 4C, a fixation portion 192 is formed by heating to melt part of the protrusion 191 of the lid member 150. As a result of melting, the protrusion 191 deforms to have an outer diameter larger than the inner diameter of the through hole 164, and thus the lid member 150 is held at the positions of the protrusion 191 and the through hole 164 and no longer separates from the partition member 140. That is, the fixation portion 192 of the protrusion 191 is positioned in the vicinity of the absorbent body 130 on the through hole 164 and fixes the lid member 150 to the partition member 140. The fixation portion 192 is formed to be easily detachable. The shape of the protrusion 191 is not limited to a cylindrical shape, and the shape of the through hole 164 is not limited to a circular shape.

FIGS. 4D to 4E illustrate a process of joining the lid member 150 to which the partition member 140 is attached, and the container 120. FIG. 4D illustrates a state before the lid member 150 to which the partition member 140 is attached and the container 120 are joined together. As illustrated in in FIG. 4D, a tip portion 196 of the protrusion 191 of the lid member 150 and the rib portions 142 of the partition member 140 protrude in the negative Z-axis direction.

Furthermore, the absorbent body 130 is inserted in advance into the container 120, and the liquid is held in the absorbent body.

Next, as illustrated in FIG. 4E, the lid member 150 to which the partition member 140 is attached is brought into contact with the opening portion 122 of the container 120, and the partition member 140 is inserted inside of the container 120. As a result of insertion of the partition member 140, the lid member 150 is placed on the opening portion 122 of the container 120, and the welding rib 195 of the lid member 150 is brought into contact with the opening portion 122 of the container 120. At this time, the rib portions 142 of the partition member 140 is pressed against the absorbent body 130, and a part of the protrusion 191 is inserted into the absorbent body 130. The relationship between a length A of the protrusion 191 and a distance B between the lid member 150 and the absorbent body 130 is set to be the length A>the distance B. As a result of such a relationship, the part of the protrusion 191 is inserted into the absorbent body 130. The longer the difference between the length A and the distance B, the longer the length of the protrusion 191 inserted into the absorbent body 130, which facilitates a process of separating the absorbent body 130 from the container 120, which will be described below. The closer the protrusion 191 is to the rotation axis in the X direction, the more firmly the protrusion 191 engages with the absorbent body 130 in the X direction during separation, making it easier to separate the absorbent body 130. However, the separation method is not limited to the above. Moreover, it is desirable that the tip portion 196 of the protrusion 191 have a sharp shape that is advantageous for being inserted into the absorbent body 130. By roughening the surface of the protrusion 191 during molding or when the fixation portion 192 is formed, the frictional force with the absorbent body 130 increases, making it easier to separate the absorbent body 130 from the container 120.

A plurality of protrusions 191 and/or a plurality of tip portions 196 can be provided.

### (Vibration Welding Process)

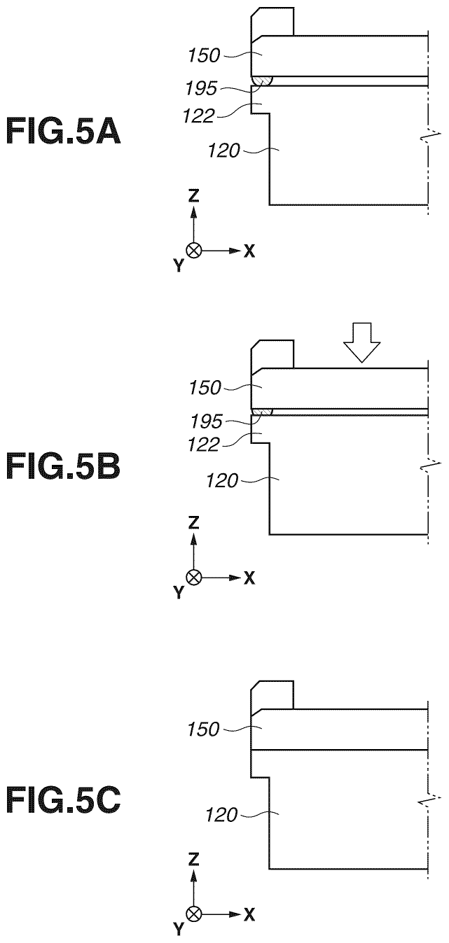

FIGS. 5A to 5C illustrate a vibration welding process for the container 120 and the lid member 150 attached to the partition member 140. First, as illustrated in FIG. 5A, the lid member 150 is placed on the opening portion 122 of the container 120, and the welding rib 195 of the lid member 150 and the opening portion 122 of the container 120 are brought into contact with each other. Next, as illustrated in FIG. 5B, the lid member 150 is caused to vibrate while being pressed against the container 120 with a predetermined pressure. The directions of the vibration of the lid member 150 are the X-axis directions of the lid member 150. It is desirable that the vibration amplitude be between 0.5 millimeters (mm) and 2.0 mm, and the vibration frequency be between 200 Hertz (Hz) and 400 Hz, which are not limited to these ranges. Vibration of the lid member 150 relative to the container 120 generates frictional heat at the contact point between the container 120 and the welding rib 195, the heat melts the opening portion 122 of the container 120 and the welding rib 195, and thus, as illustrated in FIG. 5C, the container 120 and the lid member 150 are joined together.

In the present exemplary embodiment, vibration welding is used as a method for joining the lid member 150 and the container 120. However, as long as the lid member 150 and the container 120 can be joined, the method is not limited to vibration welding.

### (Remanufacturing of Cartridges)

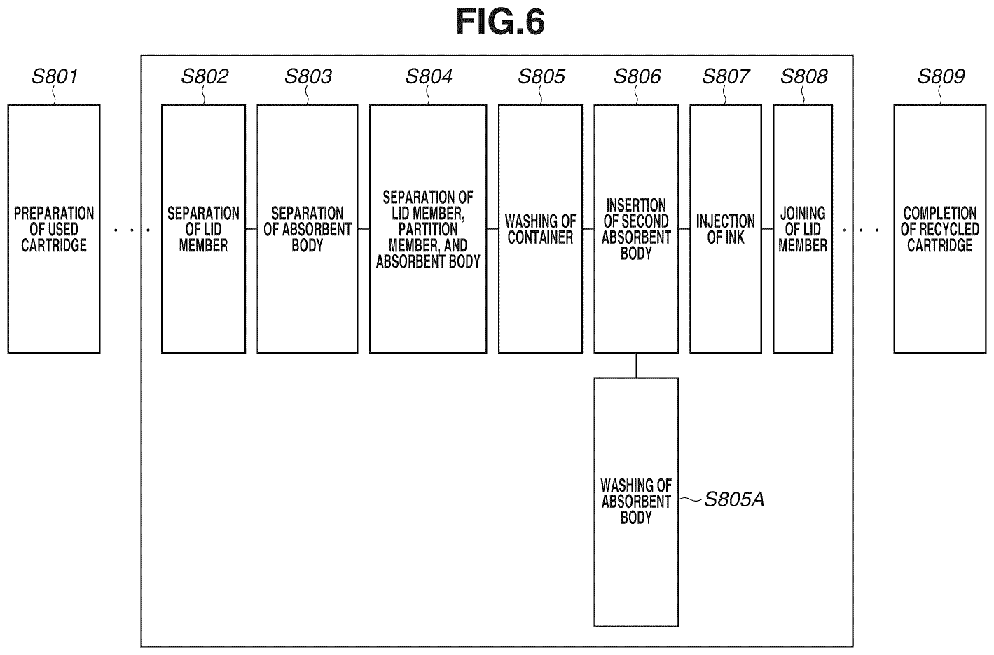

FIG. 6 illustrates a flowchart for remanufacturing the cartridge 100. Step S801 in FIG. 6 represents a process of preparing a used cartridge 100. For example, after the cartridge 100 is delivered in the market, the used cartridge 100 is collected and prepared.

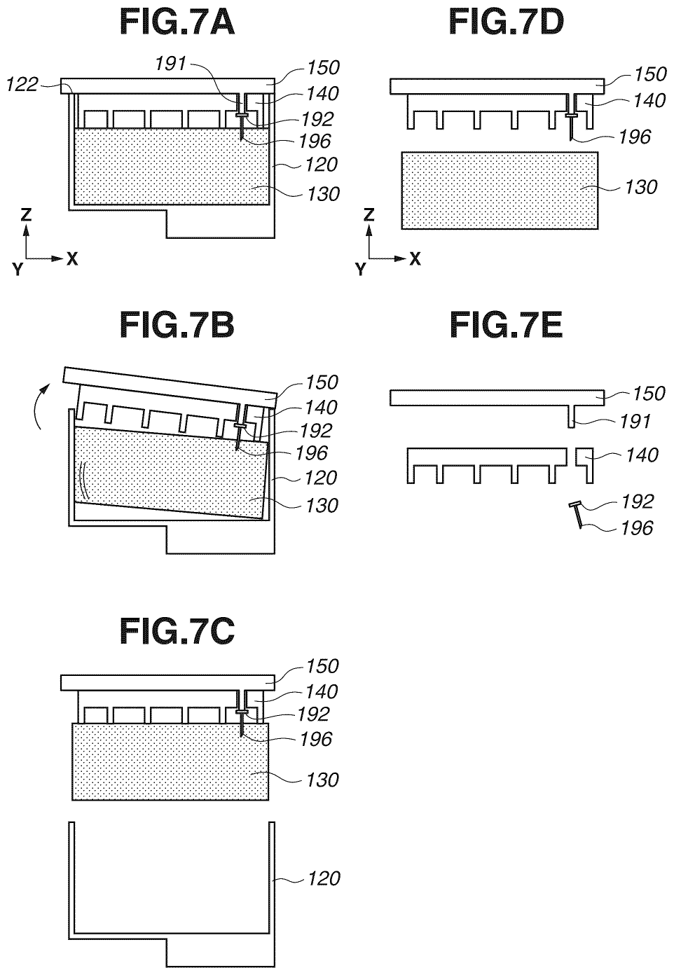

Next, in step S802, the lid member 150 is separated from the opening portion 122 of the container 120. FIGS. 7A to 7E illustrate the details of the process of separating the lid member 150 from the opening portion 122 of the container 120. FIG. 7A illustrates a state in which the above-described used cartridge 100 is prepared. First, as illustrated in FIG. 7B, the lid member 150 is moved relative to the container 120 in the +Z-axis direction to separate the lid member 150. At this time, since the lid member 150 and the partition member 140 are held together by the fixation portion 192, the separation of the lid member 150 from the container 120 results in simultaneous movement of the partition member 140 in the +Z-axis direction. Furthermore, since the tip portion 196 of the protrusion 191 of the lid member 150 is inserted into the absorbent body 130, the separation of the lid member 150 from the container 120 also results in movement of the absorbent body 130 in the +Z-axis direction. FIG. 7C illustrates a state in which the lid member 150 is further moved in the +Z-axis direction relative to the container 120. In this way, the container 120 and the lid member 150 are completely separated, and the separation of the lid member 150 from the container 120 results in separation of the partition member 140 and the absorbent body 130 from the container 120.

Next, in step S804, as illustrated in FIG. 7D, by relatively moving the protrusion 191 and the tip portion 196 of the lid member 150 away from the absorbent body 130 in the +Z-axis direction, the lid member 150 and the absorbent body 130 are separated. Finally, as illustrated in FIG. 7E, by applying stress to the fixation portion 192, the lid member 150 and the partition member 140 are separated. As described above, it is desirable that the fixation portion 192 fixe the lid member 150 to the partition member 140 to an extent that the lid member 150 and the partition member 140 can be easily separated.

As described above, by inserting a part of the protrusion 191 of the lid member 150 into the absorbent body 130, the absorbent body 130 can be easily separated from the container 120 even if the absorbent body 130 is closely fitted in the container 120 or if liquid firmly adheres to the absorbent body 130. Furthermore, since the separation of the lid member 150 from the container 120 can result in the separation of the absorbent body 130 from the container 120, reducing the increase in the takt time.

Next, in step S805, the inside of the container 120 is washed to remove stain, such as ink. Next, in step S806, a new absorbent body (also referred to as a second absorbent body) is placed in the container 120. Next, in step S807, new ink is injected into the container 120 and the ink is held in the second absorbent body. Next, in step S808, a new lid member (a second lid member) is joined to the opening portion 122 of the container 120. As a result, in step S809, the remanufactured cartridge 100 is obtained. The process of joining the second lid member can be performed using the same method as that for joining the lid member 150 to the opening portion 122 of the container 120.

In step S806 of inserting the absorbent body, the absorbent body 130 to be inserted into the container 120 can be an absorbent body 130 that has been separated in step S804 and washed in step S805A. In step S805A of washing the absorbent body, washing is performed not only by causing the washing liquid to permeate in one direction and then sucking and discharging the washing liquid, but also by immersing the entire absorbent body 130 in the washing liquid such that the washing liquid is absorbed throughout the absorbent body 130. The absorbent body 130 can be washed by being pressed and deformed in the washing liquid, and thus the remaining ink can be sufficiently removed.

It is desirable to fix the second lid member and the partition member 140 by fastening thermally before step S807. This improves the ease of handling in the subsequent processes. In addition, since the partition member 140 is not joined to the container 120, it is desirable that the partition member 140 be reused. The reuse of the partition member 140 allows improvement of the weight-based recycling rate of the cartridge 100, making the cartridge 100 more environmentally friendly.

Once the lid member 150 is joined to the container 120, the thickness of the welding rib 195 is reduced even if the lid member 150 is separated from the container 120. Thus, in remanufacturing the cartridge 100, it is desirable to use a new lid member (a second lid member).

Here, in the present exemplary embodiment, the shape of the partition member 140 is elongated, and the aspect ratio of the partition member 140 (here, the ratio of length and width) can be 1:4, and desirably the short dimension is 15.2 mm and the long dimension is 64 mm. The cartridge 100 according to the present exemplary embodiment of the present disclosure need not necessarily be of the head-integrated type.

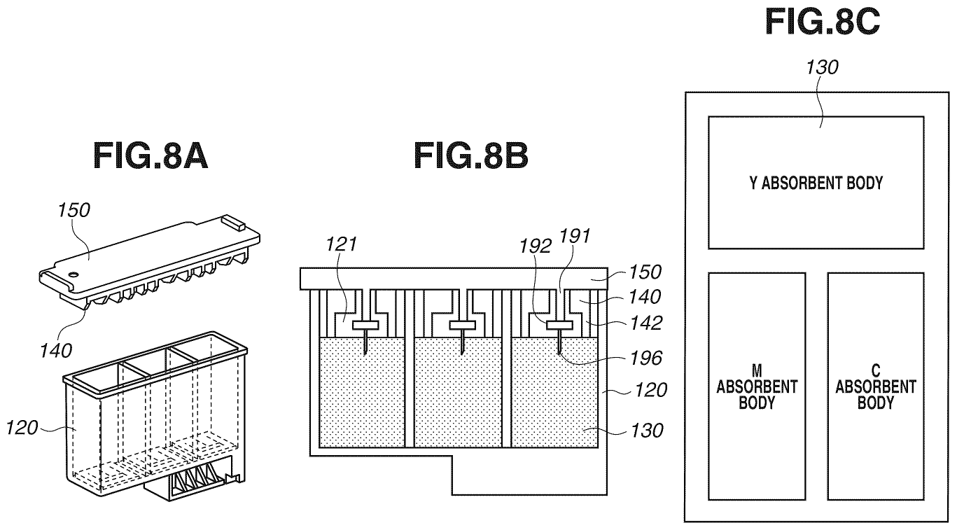

The structures, fixing methods, separation methods, and remanufacturing methods of the lid member 150 and the partition member 140 in the present exemplary embodiment of the present disclosure can be applied to the container 120 in any shape. For example, the structures, fixing methods, separation methods, and remanufacturing methods according to the present exemplary embodiment of the present disclosure are applicable to a cartridge having a configuration in which the container 120 has a plurality of absorbent body containment chambers as illustrated in FIG. 8A. FIG. 8B is a schematic cross-sectional view of the cartridge according to the present disclosure in which the lid member 150 and the partition member 140 are attached to the container 120. As illustrated in FIG. 8B, the cartridge can have a configuration in which a plurality of absorbent body containment chambers is arranged in a longitudinal direction of the cartridge. Even when a plurality of absorbent bodies is contained in the plurality of absorbent body containment chambers, by providing a plurality of protrusions 191 of the lid member 150 each being inserted into the corresponding absorbent body of the absorbent bodies, the separation of the lid member 150 from the container 120 can cause removal of the plurality of absorbent bodies 130. In the prior art, the more absorbent bodies the cartridge has, the more problematic the process of separating the absorbent bodies becomes. Thus, the configuration according to the present exemplary embodiment is suitable for a cartridge that contains a plurality of absorbent bodies 130. In addition, the structures, fixing methods, separation methods, and remanufacturing methods according to the present exemplary embodiment of the present disclosure are also applicable to a configuration illustrated in FIG. 8C where the container 120 is divided into three by a T-shaped wall in the Z-axis direction, and the absorbent body is disposed in a part of the absorbent body containment chamber.

As described above, according to the present disclosure, the cartridge 100 in which the absorbent body 130 can be easily separated from the container 120, and that reduces the risk of the increase in the takt time and the method for remanufacturing the cartridge 100 can be provided.

The configuration of the cartridge 100 according to a second exemplary embodiment of the present disclosure will be described. In the following description, only the parts that are different from the first exemplary embodiment will be mainly described, and the description of the parts that are the same as those of the first exemplary embodiment will be omitted.

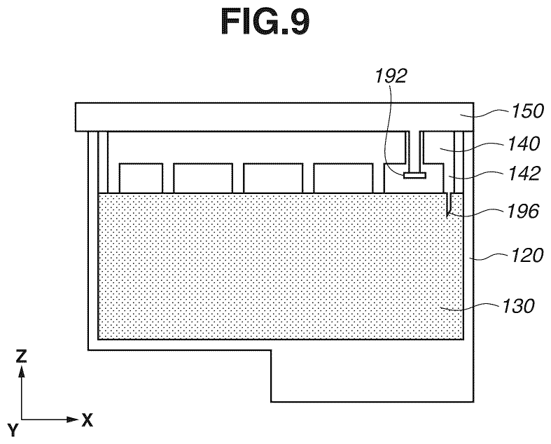

FIG. 9 is a cross-sectional view of a cartridge 100 according to the second exemplary embodiment. The present exemplary embodiment differs from the first exemplary embodiment in that instead of the protrusion 191 of the lid member 150 being inserted into the absorbent body 130, a tip portion 196 of the rib portions (protrusions) 142 of the partition member 140 is inserted into the absorbent body 130. Since the lid member 150 and the partition member 140 are pieced together at the fixation portion 192, the separation of the lid member 150 from the container 120 results in the separation of the partition member 140 from the container 120, and thus results in the separation of the absorbent body 130 in which the protrusion (tip portion 196) of the partition member 140 is inserted from the container 120. The protrusion (tip portion 196) can be provided at a location other than the rib portions 142. The method for adding the fixation portion 192 is the same as in the first exemplary embodiment.

Furthermore, when the cartridge 100 includes a plurality of absorbent bodies 130, it is desirable that the partition member 140 have a plurality of protrusions (tip portions 196) and that each of the protrusions (tip portions 196) be inserted into the corresponding absorbent body of the absorbent bodies 130.

The method for remanufacturing the cartridge 100 according to the second exemplary embodiment is similar to that of the first exemplary embodiment.

As described above, even if a protrusion is formed on the partition member, a cartridge in which the absorbent body can be easily separated from the container and that reduces the risk of the increase in the takt time and a method for remanufacturing the cartridge can be provided.

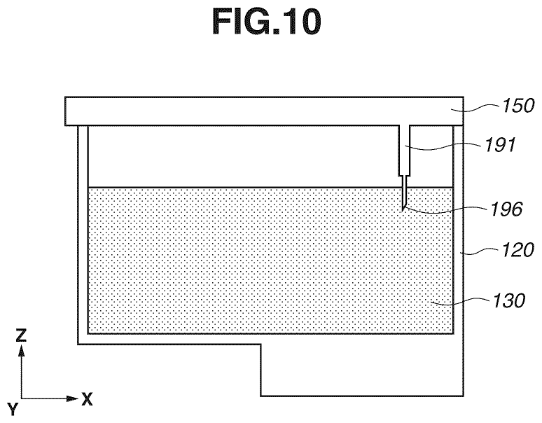

FIG. 10 illustrates a cartridge 100 according to a third exemplary embodiment. The third exemplary embodiment differs from the first embodiment in that the third exemplary embodiment does not include the partition member 140. While the partition member 140 is not included, the tip portion 196 of the protrusion 191 of the lid member 150 is inserted into the absorbent body 130, and thus the separation of the lid member 150 from the container 120 results in the separation of the absorbent body 130 from the container 120. In the third exemplary embodiment, since the partition member 140 is not provided, it is desirable that the protrusion 191 have high rigidity so as to press the absorbent body 130. One method for increasing the rigidity of the protrusion 191 is increasing the diameter of the protrusion 191. In the third exemplary embodiment, since the partition member 140 is not provided, the fixation portion 192 is not formed.

The method for remanufacturing the cartridge 100 according to the third exemplary embodiment is similar to that of the first exemplary embodiment.

As described above, even if a partition member is not provided, as long as the protrusion of the lid member is inserted into the absorbent body, a cartridge in which the absorbent body can be easily separated from the container and that reduces the risk of the increase in the takt time and a method for remanufacturing the cartridge can be provided.

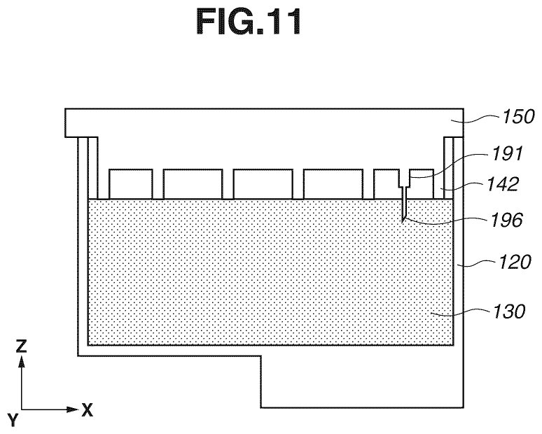

FIG. 11 illustrates a cartridge 100 according to a fourth exemplary embodiment. The cartridge 100 according to the fourth exemplary embodiment differs from the first exemplary embodiment in that the fourth exemplary embodiment does not include the partition member 140, and the rib portions 142 is provided on the lid member 150. That is, the fourth exemplary embodiment differs from the first exemplary embodiment in that the lid member 150 presses the absorbent body 130, and thus also functions as the partition member 140. In other words, the fourth exemplary embodiment is different from the first exemplary embodiment in that the lid member and the partition member are integrally formed. Even in the case of such a configuration, the lid member 150 has the protrusion 191, and the tip portion 196 of the protrusion 191 is inserted into the absorbent body 130, and thus the separation of the lid member 150 from the container 120 can result in the separation of the absorbent body 130 from the container 120. In the present exemplary embodiment, since there is no need to provide the partition member 140 separately from the lid member 150, there is no need to piece together the partition member 140 and the lid member 150. Thus, the increase in the takt time can be further reduced.

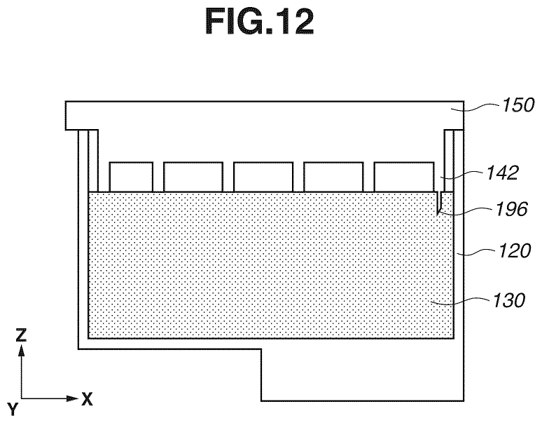

In FIG. 11, the protrusion 191 is formed on a portion of the lid member 150 other than the rib portions 142, but as illustrated in FIG. 12, the protrusion 191 (tip portion 196) can be formed on one of the rib portions 142.

The method for remanufacturing the cartridge 100 according to the fourth exemplary embodiment is similar to that of the first exemplary embodiment.

As described above, even if the lid member also functions as a partition member, as long as the protrusion of the lid member is inserted into the absorbent body, a cartridge in which the absorbent body can be easily separated from the container and that reduces the risk of the increase in the takt time and a method for remanufacturing the cartridge can be provided.

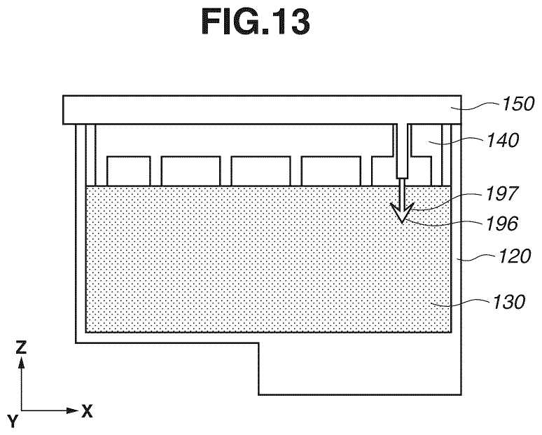

FIG. 13 illustrates a cartridge 100 according to a fifth exemplary embodiment. The cartridge 100 according to the fifth exemplary embodiment differs from the first exemplary embodiment in that a claw portion 197 extending toward the lid member is formed on the tip portion 196 of the protrusion 191 that is inserted in the absorbent body 130. The claw portion 197 further facilitates the separation of the absorbent body 130 from the container 120, because the claw portion 197 catches the absorbent body 130 in the separation of the absorbent body 130 from the container 120 resulted from the separation of the lid member 150 from the container 120.

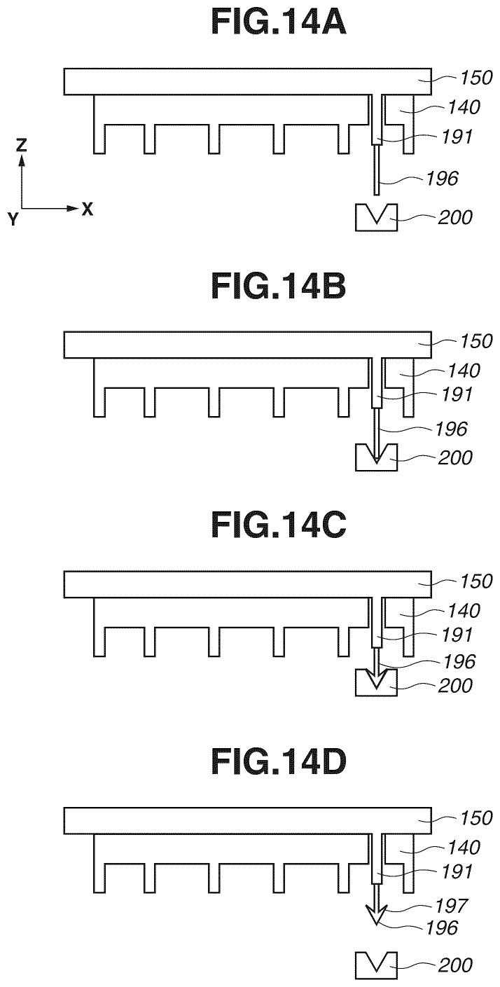

FIGS. 14A to 14D illustrate a method for forming the claw portion 197. FIG. 14A illustrates a state before the claw portion 197 is formed on the lid member 150 using a mold member 200. The space that matches the shape of the claw portion 197 to be formed is formed in the mold member 200. FIG. 14B illustrates a process of bringing the mold member 200 into contact with the tip portion 196 of the protrusion 191 of the lid member 150. The mold member 200 has a higher melting point than the tip portion 196. Next, FIG. 14C illustrates a process of heating the tip portion 196 to melt the tip portion 196. In this process, the mold member 200 supports the tip portion 196 being melted, and thus the tip portion 196 is deformed into a shape similar to the space formed in the mold member 200. Finally, FIG. 14D illustrates a process of separating the mold member 200 after the temperature of the tip portion 196 has dropped, that is, after the tip portion 196 has cooled and solidified. Through the above processes, the claw portion 197 is formed on the tip portion 196.

The method for remanufacturing the cartridge 100 according to the fifth exemplary embodiment is similar to that of the first exemplary embodiment.

As described above, by forming a claw portion on a part to be inserted into the absorbent body, a cartridge in which the absorbent body can be easily separated from the container and that reduces the risk of the increase in the takt time and a method for remanufacturing the cartridge can be provided.

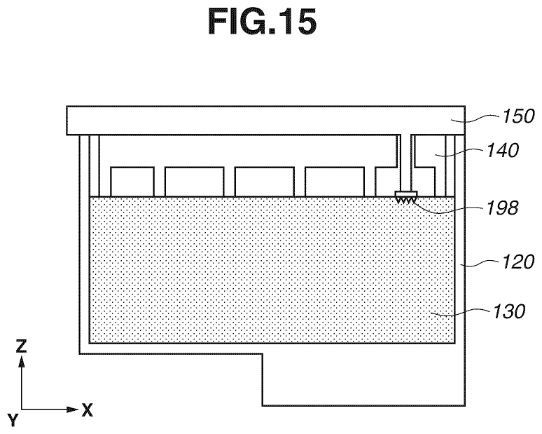

FIG. 15 illustrates a cartridge 100 according to a sixth exemplary embodiment. In the cartridge 100 according to the sixth exemplary embodiment, an uneven portion 198 is formed on the tip portion 196 of the protrusion 191 inserted into the absorbent body 130. The uneven portion 198 facilitates the separation of the absorbent body 130 from the container 120 resulted from the separation of the lid member 150 from the container 120, because the uneven portion 198 increases the contact area and frictional force between the uneven portion 198 and the absorbent body 130.

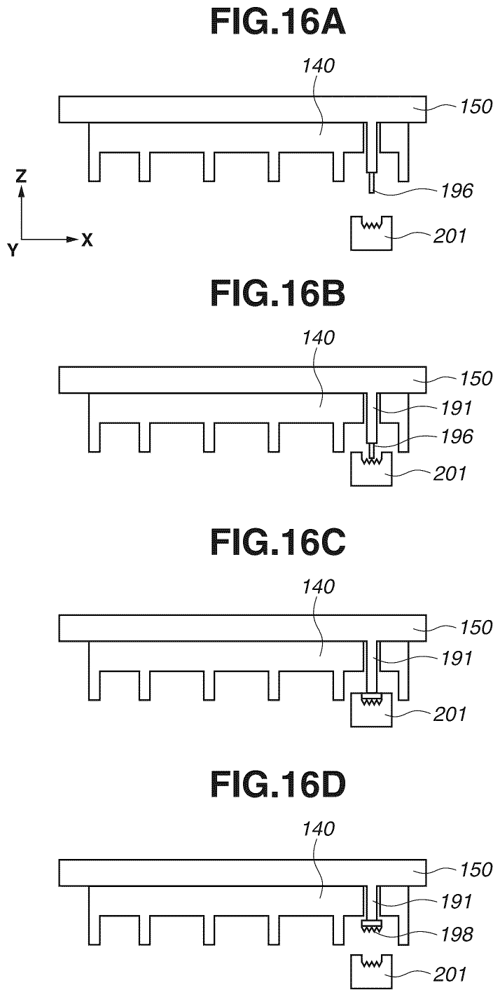

FIGS. 16A to 16D illustrate a method for forming the uneven portion 198. FIG. 16A illustrates a state before the uneven portion 198 is formed on the protrusion 191 of the lid member 150 using a mold member 201. The space that matches the shape of the uneven portion 198 to be formed is formed in the mold member 201. FIG. 16B illustrates a process of bringing the mold member 201 into contact with the tip portion 196 of the protrusion 191 of the lid member 150.

The mold member 201 has a higher melting point than the tip portion 196. Next, FIG. 16C illustrates a process of heating the tip portion 196 to melt the tip portion 196. In this process, the mold member 201 supports the tip portion 196 being melted, and thus the tip portion 196 is deformed into a shape similar to the space formed in the mold member 201. Finally, FIG. 16D illustrates a process of separating the mold member 201 after the temperature of the tip portion 196 has dropped, that is, after the tip portion 196 has cooled and solidified. Through the above processes, the uneven portion 198 is formed in the tip portion 196.

The method for remanufacturing the cartridge 100 according to the sixth exemplary embodiment is similar to that of the first exemplary embodiment.

As described above, by forming an uneven portion on a part to be inserted into the absorbent body, a cartridge in which the absorbent body can be easily separated from the container and that reduces the risk of the increase in the takt time and a method for remanufacturing the cartridge can be provided. Thus, the present disclosure will facilitate remanufacturing of cartridges, and thus the technologies described in this specification have the potential to contribute to the achievement of a sustainable society, such as a decarbonized/circular society.

An embodiment in which the constituent elements in the above-described exemplary embodiments are appropriately combined can be applied.

According to the present disclosure, a cartridge in which the absorbent body can be easily separated from the container and that reduces the risk of the increase in the takt time and a method for remanufacturing the cartridge can be provided.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Applications No. 2023-209162, filed Dec. 12, 2023, and No. 2024-183263, filed Oct. 18, 2024, which are hereby incorporated by reference herein in their entirety.

What is claimed is:

1. A cartridge comprising:
at least one absorbent body holding liquid;
at least one container having an opening portion, the at least one absorbent body being housed in the container; and
a lid member configured to be joined to the opening portion,
wherein the lid member includes at least one protrusion, and
wherein a part of the at least one protrusion is inserted into the at least one absorbent body.

2. The cartridge according to claim 1, further comprising a partition member disposed between the at least one absorbent body and the lid member, and a through hole being formed in the partition member,
wherein the at least one protrusion is inserted through the through hole.

3. The cartridge according to claim 2, wherein the at least one protrusion includes a fixation portion that fixes the lid member to the partition member.

4. The cartridge according to claim 3,
wherein a diameter of the fixation portion is larger than an inner diameter of the through hole, and
wherein the fixation portion is positioned in a vicinity of an opening of the through hole facing the at least one absorbent body.

5. The cartridge according to claim 2, wherein a length of the at least one protrusion is longer than a distance between the lid member and the at least one absorbent body.

6. The cartridge according to claim 1, wherein a claw portion extending toward the lid member is formed on the part of the at least one protrusion, the part being inserted into the at least one at least one absorbent body.

7. The cartridge according to claim 1, wherein an uneven portion is formed on a part of the at least one protrusion, the part being inserted into the at least one absorbent body.

8. The cartridge according to claim 1,
wherein the at least one absorbent body comprises a plurality of absorbent bodies;
wherein the at least one container comprises a plurality of containers,
wherein the at least one protrusion comprises a plurality of protrusions,
wherein the plurality of absorbent bodies is each stored in a corresponding container of the plurality of containers, and
wherein the lid member includes the plurality of protrusions, and the plurality of protrusions is each inserted into a corresponding absorbent body of the plurality of absorbent bodies.

9. The cartridge according to claim 8, wherein the plurality of containers is arranged in a longitudinal direction of the cartridge.

10. The cartridge according to claim 2, wherein the lid member and the partition member are integrally formed.

11. A cartridge, comprising:
at least one absorbent body holding liquid;
at least one container having an opening portion, the at least one absorbent body being housed in the at least one container;
a lid member configured to be joined to the opening portion; and
a partition member disposed between the absorbent body and the lid member,
wherein the lid member and the partition member are pieced together, and
wherein the partition member includes at least one protrusion, and the at least one protrusion is inserted into the absorbent body.

12. The cartridge according to claim 11,
wherein the at least one absorbent body comprises a plurality of absorbent bodies;
wherein the at least one container comprises a plurality of containers,
wherein the at least one protrusion comprises a plurality of protrusions,
wherein the plurality of absorbent bodies is each housed in a corresponding container of the plurality of containers, and
wherein the lid member includes the plurality of protrusions, and the plurality of protrusions is each inserted into a corresponding absorbent body of the plurality of absorbent bodies.

13. The cartridge according to claim 11, wherein a claw portion extending toward the lid member is formed on a part of the at least one protrusion that is inserted into the at least one absorbent body.

14. A method for remanufacturing a cartridge, the method comprising:
preparing a cartridge including an absorbent body holding liquid, a container having an opening portion, and a lid member configured to be joined to the opening portion and including a protrusion, the absorbent body being stored in the container, the protrusion being inserted into the absorbent body; and
separating the lid member from the opening portion,
wherein the separating results in separation of the absorbent body from the container.

15. The method for remanufacturing a cartridge according to claim 14, the method further comprising:
washing an inside of the container;
putting a second absorbent body into the container;
injecting the liquid into the container; and
joining a second lid member to the opening portion.

16. The method for remanufacturing a cartridge according to claim 14, wherein the preparing includes preparing a cartridge including a partition member disposed between the absorbent body and the lid member, a through hole is formed in the partition member, and the protrusion is inserted into the through hole.

17. The method for remanufacturing a cartridge according to claim 16, wherein the protrusion has a fixation portion that fixes the lid member to the partition member.

18. The method for remanufacturing a cartridge according to claim 17, wherein the separating results in separation of the partition member from the container.
